(19) United States
(12) Patent Application Publication
(10) Pub. No.: US 2004/0122637 A1
(43) Pub. Date: Jun. 24, 2004

(54) System and methods for development and testing of payload interaction

(75) Inventors: Bill Askew, Dayton, TX (US); Matthew Barry, Monrovia, CA (US); Roger Luty, Friendswood, TX (US); Jon Morsics, Lake Jackson, TX (US); Ayman Quaddumi, Houston, TX (US); James Calvert Thompson, Pearland, TX (US)

Correspondence Address: GREENBERG-TRAURIG, 1750 TYSONS BOULEVARD, 12TH FLOOR, MCLEAN, VA, 22102, US

(73) Assignee: United Space Alliance, LLC, Houston, TX

(21) Appl. No.: 10/680,692

(22) Filed: Oct. 8, 2003

Related U.S. Application Data
(60) Provisional application No. 60/416,530, filed on Oct. 8, 2002.

(51) Int. Cl. G06F 17/10

(52) U.S. Cl. 703/2

(57) ABSTRACT

An embedded real-time operating system model which uses flight software to verify commands, fault annunciations, and telemetry acquisition is provided. The system includes or provides an avionics emulator, emulation of craft avionics and other components, complying command data or mission simulation software, and a portable computer for the cargo PC in a system to allow analysis of a payload and its interaction without access to actual flight computers of the craft.

Priority is claimed based upon U.S. Provisional Patent Application Serial No. 60/416,530 filed on Oct. 8, 2002, which is fully incorporated herein by reference.

The U.S. Government has certain license rights with respect to the invention claimed herein pursuant to the terms of Contract No. NAS9-20000 between United Space Alliance, LLC and the National Aeronautics & Space Administration (“NASA”).

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates to the field of simulator systems for the testing and interaction of craft payloads. Specifically, the present invention relates to the field of spacecraft, such as the Space Shuttle, simulator systems for testing the interaction of the payload with the craft and for testing the dynamics on a given payload caused by movement of the craft.

### BACKGROUND OF THE INVENTION

Current technology discloses simulator systems which simulate the instrumentation and operation of an aircraft or satellite.

### SUMMARY OF THE INVENTION

Accordingly, the present invention is directed to a system and methods for development and testing of payload interaction that substantially obviates one or more of the problems due to limitations and disadvantages of the related art.

An object of the present invention is to provide a system which simulates the actual on board computer and other systems of a craft, such as the Space Shuttle, as well as simulates flight or movement of the craft in relation to the payload being carried and/or operated through the craft.

In a preferred embodiment the present invention will be used by payload clients at locations remote from the launch site and dedicated flight computer systems to simulate the interaction with the Space Shuttle for aiding the design and testing of payloads, associated payload software, and operation of the payload. In this manner, clients and agencies can prepare and model their payloads remotely, thus minimizing the time necessary to prepare on-site payloads and simulate their performance.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings and appendices.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

### DETAILED DESCRIPTION OF THE PREFERRED EMBODIMENT

Reference will now be made in detail to the preferred embodiments of the present invention, examples of which may be illustrated in the accompanying drawings.

The present invention provides an embedded real-time operating system model which uses flight software to verify commands, fault annunciations, and telemetry acquisition. Specific features of the present invention include the avionics emulator, emulation of shuttle avionics and other components, complying command data or mission simulation software, and a portable computer for the cargo PC in a system to allow analysis without access to actual flight computers.

The present invention is comprised of a multitude of components, software applications, and subsystems including at least the: (1) Orbiter-in-a-Box Tool, (2) Command and Data Tool, (3) Project Missions Operations Tool, and (4) General Purpose Computer Emulator Platform. The present invention comprises a system which allows users to simulate and/or emulate a payload's interaction with a craft, such as an evolved extended launch vehicle or the Space Shuttle, including the crafts on-board computers enabling the user to perform developmental activities on the payload hardware and associated software even without access to the launch agency' computer systems. The system as a whole, subsystems, and components each have unique and novel features and functions which at least allow a user to test, analyze, and develop: (i) any interface between the payload and the craft's computers; (ii) any command, serial communications, and telemetry interface; (iii) any Cargo PC application software against the General Purpose Computer Payload Command Filter (“GPCF”) which enables the user to verify commands, fault annunciations, and telemetry; and (iv) the performance or interaction of a payload against emulated and/or simulated craft avionics components.

Orbiter-in-a-Box Tool

The Orbiter-in-a-Box Tool is an embedded real-time operating system model of the orbiter avionics sufficient to perform payload hardware, Cargo PC software, and payload model software development activities. The Orbiter-in-a-Box Tool was designed and created to test the orbiter interface between the Cargo PC and the customer's payload. The Orbiter-in-a-Box Tool provides telemetry and a serial communications interface for the Cargo PC, and it provides a telemetry and commanding interface for the payload. In conjunction with the Command and Data Tool, the Orbiter-in-a-Box Tool provides the capability to test the Cargo PC application software against the GPCF function from real flight software, enabling the user to verify commands, fault annunciations, and telemetry.

The present invention is designed to be sufficiently portable to take automated tools to a user site and allow the user to create products models and data that are necessary for shuttle payload training and operations. These products could become a requirement prior to the final manifesting of a payload to ensure that the payload's performance has been sufficiently considered. The present invention will enable a shorter mission preparation template. The new reduced flight operations template will allow a substantial reduction in infrastructure cost. The present invention may include a portable personal computer or “Cargo PC” that will provide payload data display and control capability to the craft crew. The Cargo PC will decouple the Payload and Orbiter software build processes and allow payload data to be accurately assembled by the payload client. The Payload customer or user will develop the appropriate Cargo PC software, data and payload models used in the Shuttle Mission Simulator (“SMS”). The Payload customer will deliver the specific payload training models and payload operations information in the format required by the mission operations team.

Reducing the flight operations template and requiring the client user to develop and test the Cargo PC application software and SMS training model, and provide payload operations information positively affects the payload customer and the Flight Operations community. However, these conditions increase the risk that the flight operations template process will not be negotiated smoothly such that the customers and products are not ready to fly. Thus, a successful solution would provide a set of tools that assist the customer to produce the Cargo PC software, SMS training model, and supporting payload operations documentation according to expectations that ensure a smooth negotiation of the flight operations template.

The Orbiter-in-a-Box will provide a simulated MDM serial I/O port for Cargo PC commanding, and it will provide a simulated PCMMU telemetry interface for Cargo PC input data. Prior to integrated testing the Orbiter-in-a-Box will enable the customer or user to perform early checks and analysis on the payload communications interfaces with the orbiter avionics. Among its other functions, the Orbiter-in-a-Box Tool provides a way to test the Cargo PC software in the field by running the real orbiter flight software. The Orbiter-in-a-Box will also make possible early validation of payload operating procedures.

Command and Data Tool

The present invention includes a Command and Data Tool which acts as a client-server database application that will be used to collect the command and telemetry data for the Cargo PC payload. In conjunction with the Orbiter-in-a-Box Tool, the Command and Data Tool provides the capability to test the Cargo PC application software against the GPCF function from real flight software, enabling the customer or user to verify commands, fault annunciations, and telemetry. Inputs to the Command and Data Tool are command and data requirements including telemetry stream data structure, all commands, safety monitoring parameters, and limit checks. The Command and Data Tool produces and stores Extended Markup Language (XML) files and payload specific GPCF tables. In addition, the Command and Data Tool manages reconfiguration data for the Cargo PC and the Orbiter-in-a-Box.

The Command and Data Tool (“CDT”) and other supportive POST tools will be delivered to a customer site and used to created products that are necessary for payload training and operations on the specific launch vehicle intended. The CDT will allow the customer to create reconfiguration tables by soliciting from the customer the information necessary to reconfigure the Cargo PC, orbiter GPCF flight software, mission control center, and training models. In order to support complex telemetry from a customer payload, the CDT collects a set of customer format information for WinDecom, a component of the Cargo PC, to process the complex telemetry. In addition, the CDT's audit capability allows users to review the payload requirements that are entered. The CDT and other supporting POST Tools will enable a shorter mission preparation template which will allow a substantial reduction in infrastructure cost. The Command and Data Tool's audit capability and data entry guidelines will reduce costs in terms of software maintenance and data quality control.

Missions Operations Tool

The Mission Operations Tool (MOT) will be used to collect payload operations data for developing standard mission operations products. This tool provides a streamlined and simplified way to collect the data to support the development of mission operations documentation including Payload Integration Plan (PIP) annexes, payload operations procedures, and flight rule information.

The Mission Operations Tool collects payload operations and flight rule information for mission planning and real-time flight control support. MOT will use a client-server configuration. In the field, the server component can run on the POST Tools PC; at home, the server component can run on the POST USA server. The Mission Operations Tool's client component can run on any PC supporting Java, including the POST Tools PC. Parts of the MOT content can be entered directly into Microsoft Office® documents. Product and data configuration management can be performed through local services and the local data store, and via remote shared data repository services. Further, MOT employs user-friendly data entry forms (Java based) to capture and store book table data in a relational database. Data entry forms pertain to basic payload information, product generation, and document schedule.

Reducing the flight operations template and requiring the customer to develop and test the Cargo PC application software and SMS training model, and provide payload operations information affects the payload customer and the Flight Operations community. These conditions increase the risk that the flight operations template process will not be negotiated smoothly such that the customers and products are not ready to fly. A successful solution would provide a set of tools that assist the customer to produce the Cargo PC software, SMS training model, and supporting payload operations documentation according to expectations that ensure a smooth negotiation of the flight operations template.

The Mission Operations Tool (MOT) and other supporting POST Tools will be delivered to a customer site and used to create products that are necessary for shuttle payload training and operations. Payload customers will use the MOT to collect payload operations data for developing standard mission operations products. Some of the MOT data collection can be conducted with a Java based tool used for collecting and storing data in the payload database on the POST Tools PC. The remainder of the MOT data collection can be performed through Microsoft Office pre-specified document templates (“bland books”) that are primarily used for formatted text entries. MOT product generation interleaves the text and database information. The tool also provides an event scheduling capability.

General Purpose Computer Emulator Platform

The present invention also includes a set of emulators and models of Space Shuttle or craft avionics components, enabling users to execute the raw binary image of the Space Shuttle flight software from inexpensive workstations. This software package includes: an emulator (virtual machine) for the Space Shuttle general purpose computer (consisting of a central processing unit, input-output processor, master sequence controller and bus control elements); an emulator of the display electronics unit and models of the CRTs, keyboards, and switch controls; models of the data bus network; models of the multiplexer-demultiplexer components; and emulation of the pulse-code modulation master unit; and emulation of the payload data interleaver; a model of the master timing unit; a model of the mass memory unit; and a mission control center “front end” to provide telemetry and command services. The software package is portable to several host platforms.

Eliminating the flight computer hardware suggested development of an emulator that would translate the software instructions meant for the flight computer platform into an instruction set for a foreign workstation platform. Whatever the platform, it must be much less expensive than, but not necessarily as reliable and rugged as, the real flight computers. The emulator also needs a variety of simulated interfaces to provide input/output communications and wired controls. For mission operations applications, the emulator must interact easily with new or existing systems for training and other activities.

The present invention includes the GPCF platform written in high-level languages (C++ and Java) to enable compilation and deployment on a variety of microprocessor platforms. The present invention adhered to applicable ANSI, ISO and POSIX standards. In addition, the present invention includes interpreter software which is fast enough to at least run at the desired rate of 25 Hz. The present invention includes an interface for the collection of vehicle and environment models to create a full-fledged simulation suitable for flight controller training which includes the ability to use existing Shuttle Mission Simulator models and integrated the emulator platform with these models. The present invention also employs a server to translate the synthetic telemetry stream from the PCMMU emulator into an MCC-compatible protocol stream to drive existing MCC application software as part of an integrated simulation.

In addition to the description of the present invention described herein, attached to this application are various appendices which are made a part of and are incorporated by reference into this application in their entirety. The appendices include:

A. High Level Data Flow

B. Product Interface Definition Document for Payload Operations

C. POST Tools Use Case Specification

D. Diagram of Orbiter-in-a-Box and POST PC Systems interface

E. Diagram of POST Architecture

F. POST Tools Project Glossary

G. POST Tools High-Level Architecture

H. POST Tools Project C3 Design Review

I. Data Recon Integration Process

J. Orbiter- in-a-Box User Manual

While the invention has been described in detail and with reference to specific embodiments thereof, it will be apparent to those skilled in the art that various changes and modifications can be made therein without departing from the spirit and scope thereof. Similarly, while the invention can be used for payloads associated with the U.S. Space Shuttle Program, it may also be used for other manned and unmanned launch vehicles and for aviation payloads. Thus, it is intended that the present invention cover the modifications and variations of this invention provided they come within the scope of the appended claims and their equivalents.

What is claimed is:

1. A system for accurately predicting payload performance at a location remote from an intended launch vehicle or its associated computer controls, comprising:
a.) A Mission Operations Tool for collecting information for payload operations products and support;
b.) A Command and Data Tool for creating command and data tables to facilitate communications with the Orbiter-in-a-Box;
c.) An Orbiter-in-a-Box Tool portable in nature and having an embedded real-time model of launch vehicle avionics capable of emulating the launch vehicle environment;
d.) A General Purpose Emulator enabling payload customers to create and test mathematical model of their payload capable of use in crew training and vehicle simulations on manned flights.

2. The system in claim 1 further comprising a Shared Data Repository wherein data for a plurality of payloads may be uploaded to a shared server to enable the launching agency to integrate such data into a model of all intended payloads for a particular flight.

3. A method for accurately predicting payload performance at a location remote from an intended launch vehicle or its associated computer controls, comprising:
a.) Distributing portable systems such as is described in claim 1 to payload customers;
b.) Allowing input from said customers concerning customer payload(s);
c.) Processing said data to form a data set capable of integration by a launching agency to form an accurate and integrated model of all intended payloads.
